(19) United States
(12) Patent Application Publication
(10) Pub. No.: US 2015/0269549 A1
(43) Pub. Date: Sep. 24, 2015

(54) SYNCHRONIZING SCAN ACTIVITY WITH LOSS PREVENTION CAMERAS

(71) Applicant: TOSHIBA GLOBAL COMMERCE SOLUTIONS HOLDINGS CORPORATION, Tokyo (JP)

(72) Inventors: Dean Frederick HERRING, Youngsville, NC (US); Jeffrey John SMITH, Raleigh, NC (US)

(73) Assignee: TOSHIBA GLOBAL COMMERCE SOLUTIONS HOLDINGS CORPORATION, Tokyo (JP)

(21) Appl. No.: 14/221,078

(22) Filed: Mar. 20, 2014

(51) Int. Cl. G06Q 20/20; H04W 4/04; H04N 7/18

(52) U.S. Cl. CPC G06Q 20/206; H04N 7/18; G06Q 20/203; H04W 4/04

(57) ABSTRACT

System, method, and computer program product to perform an operation comprising receiving, via a computer network connection, information for a product scan indicating that a product has been scanned for purchase by a mobile checkout application executing on a mobile device, and storing, in a computer-readable storage medium, a plurality of attributes describing the product scan and identification information of an image capture device in the retail store configured to capture video of the product scan.

### BACKGROUND

The present disclosure relates to computer software, and more specifically, to computer software to synchronize mobile scan activity with loss prevention cameras.

Retailers are exposed to greater risk of loss when customers, and not retail employees, are allowed to process sales transactions in a retail store. Allowing customers to use self-checkout methods increases the risk of theft, as the retail employees are not present to process each item the customer may leave the store with.

### SUMMARY

Embodiments disclosed herein include at least a system, method, and computer program product to perform an operation comprising receiving, via a computer network connection, information for a product scan indicating that a product has been scanned for purchase by a mobile checkout application executing on a mobile device, and storing, in a computer-readable storage medium, a plurality of attributes describing the product scan and identification information of an image capture device in the retail store configured to capture video of the product scan.

### BRIEF DESCRIPTION OF THE SEVERAL VIEWS OF THE DRAWINGS

FIGS. 1A-1B illustrate example security system interfaces implementing techniques to synchronize scan activity with loss prevention cameras, according to one embodiment.

FIG. 2 illustrates an example data structure to synchronize scan activity with loss prevention cameras, according to one embodiment.

FIG. 3 illustrates a system to synchronize scan activity with loss prevention cameras, according to one embodiment.

FIG. 4 is a flow chart illustrating a method to synchronize scan activity with loss prevention cameras, according to one embodiment.

FIG. 5 is a flow chart illustrating a method to identify and store mobile capture event attributes, according to one embodiment.

FIG. 6 is a flow chart illustrating a method to use synchronized data for loss prevention purposes, according to one embodiment.

### DETAILED DESCRIPTION

Embodiments disclosed herein synchronize mobile scan activity with security cameras (also referred to as loss prevention cameras, security systems, and the like). When a customer scans an item using their personal mobile device (or a mobile scanning device provided by the retailer), embodiments disclosed herein capture a plurality of attributes regarding the scan (also referred to as a “scan event” or a “capture event”), and associate one or more of the attributes with the security system. Additionally, embodiments disclosed herein may take additional actions, such as capturing one or more still images (or short video sequences) of the product scan. The attributes may include, without limitation, a timestamp, a location in the retail store where the scan took place, a mobile device identifier, a product identifier, and an identifier of a video camera configured to capture video of the location in the retail store where the scan (or other event) took place. Once captured, the attributes may be stored and associated with the security system infrastructure. For example, and without limitation, the attributes may be stored as metadata in a video captured by a security camera. As another example, the attributes may be stored in a database for retrieval by the security system software. As still another example, a graphical representation of the capture event may be generated and overlaid on a video that includes footage of the person scanning the product. The security systems may generally be configured to use the capture event data in any number of ways, including, without limitation, adding visual indicators of capture events to the captured video, creating composite images of scan activity for a given shopper, creating lists of items scanned by the shopper, and the like.

As used herein, a “capture event” includes any action by which a device is used to receive a product identifier of an item as part of a checkout operation. The device may be, for example and without limitation, an integrated point-of-sale solution, a computer, a self-checkout scanner, or mobile device. The product identifier may be, for example and without limitation, a bar code, a quick response (QR) code, or an image of the product itself (which may be analyzed to identify the product). For example, a customer-initiated capture event may occur when the customer uses a mobile shopping app on their smart phone to scan a bar code or QR code on a product. More generally, however, the device may be any device configured to read a product identifier of any type on any product. For example, a retail employee may initiate a capture event by scanning products at a fixed point-of sale solution such as a cash register. As another example, and without limitation, the mobile device may be a smart phone, tablet, or other device, such as the self-scan devices provided by many retailers that customers may use to scan items while shopping in a store. A “mobile checkout application” may be any application executing on a mobile device that allows a customer to scan and pay for products without having to go through a traditional retail store checkout process.

Although “scanning” products is used herein as an example capture method to receive a product identifier, techniques other than scanning may be used to receive the product identifier. For example, a person may manually type in a product identifier using a keyboard or other interface. As another example, video or photo recognition of a product may be used to capture product identification information.

Furthermore, events other than capture events may be associated with the security camera and related video data. For example, embodiments disclosed herein may be used to mark the time and location a customer makes a mobile payment, makes payment through a self-service pay station, or makes a payment at a traditional checkout lane. Additionally, embodiments disclosed herein may track when a customer moves an item into their basket or cart. Furthermore, embodiments disclosed herein are not limited to a single tracking device. For example, embodiments disclosed herein may track items that are captured through a kiosk for pre-weighing for produce or other bulk goods. Therefore, any type of “event” may be tracked and associated with the security system data. For example, a timestamp and other attributes may be associated with the security video data when a cashier scans each product in a traditional checkout lane.

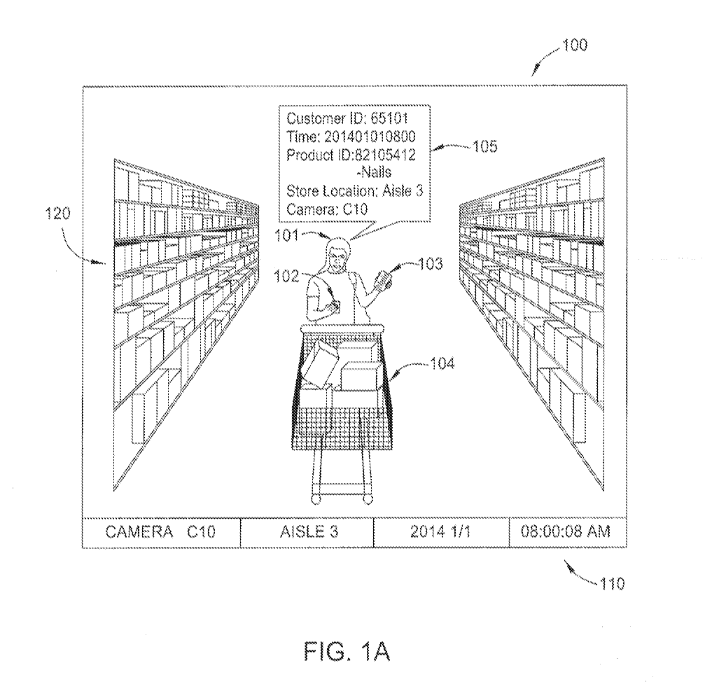

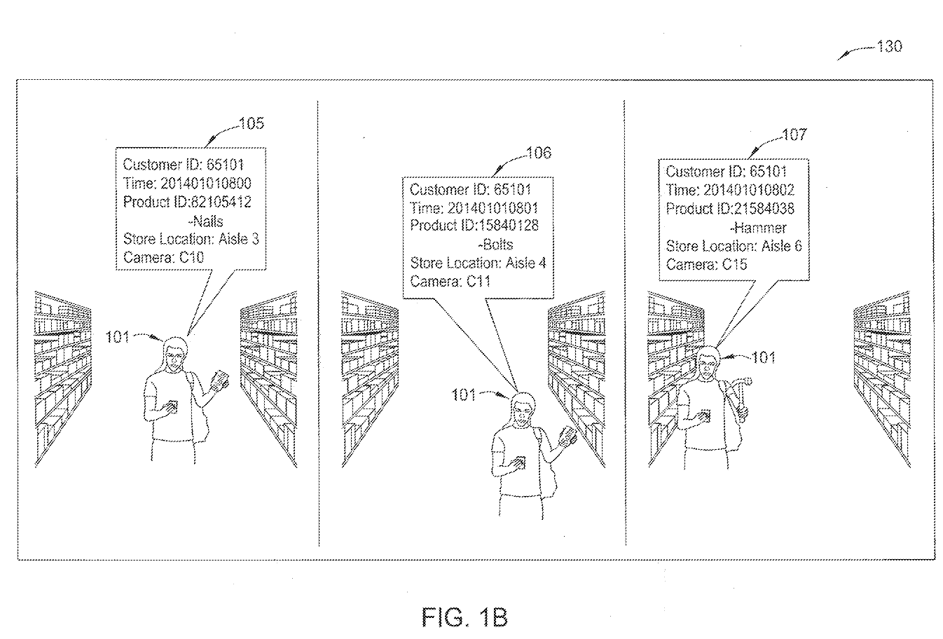

FIG. 1A illustrates an example security system interface 100 implementing techniques to synchronize scan activity with loss prevention cameras, according to one embodiment. The interface 100 depicts security video of a user 101 in a store. The interface 100 includes a detail bar 110 which depicts a security camera capturing the video, an aisle in the store, and the current date/time. Generally, security systems include a plurality of cameras that are configured to capture images and video of one or more locations in a store, and store the captured image and video data for later use. As shown, the user 101 carrying a mobile deice 102 is browsing an aisle of a retail store having two shelves 120 containing a number of different products. The mobile device 102 executes a mobile shopping application (not pictured) that allows the user 101 to scan and pay for products in the store without having to go to a traditional point-of-sale terminal to pay for the products they wish to buy. As shown, the user 101 has selected a product 103 for purchase. The product 103 may be any product, such as a box of nails. In order to add the nails 103 to a checkout list of the mobile checkout application, the user 101 uses the mobile device 102 in order to scan the box of nails 103 before putting them in the cart 104.

Because self-checkout operations introduce heightened risk to retailers, when the user 101 scans the nails 103 with the mobile device 102, embodiments disclosed herein capture a plurality of attributes (or metadata) of the capture event. For example, the mobile shopping application may transmit a unique identifier of the product, a unique identifier of the mobile device (and/or the user 101), and a timestamp indicating the exact time the capture event occurred. Embodiments disclosed herein may further determine the location of the mobile device 102 (and the user 101, by association) in order to determine what security cameras are configured to capture video of the capture event. Any method may be used to determine the location of the mobile device 102. For example, the mobile device 102 may transfer GPS coordinates or other location data. As another example, wireless signals emitted from the mobile device 102 may be triangulated in order to determine the location of the mobile device 102. The mobile device 102 may also include radio frequency identification (RFID) tags, near field communication (NFC), or any other hardware allowing the location of the mobile device 102 to be determined. As yet another example, facial recognition techniques may be used to identify the user 101 and determine their location in the store.

Once the location of the user 101 is determined, embodiments disclosed herein may identify one or more video cameras (not pictured) that are configured to capture video footage of the location in the store. For example, the security system may include mappings of locations in the store to security cameras that can capture video or images of each location in the store. Once these cameras are identified, embodiments disclosed herein may associate the captured capture event attributes with the video data captured by the identified cameras. Generally, embodiments disclosed herein may store at least one record of the capture event attributes at a storage location. For example, and without limitation, the storage location may be part of a retail transaction database, a part of the security system, or any other location configured to store the capture event attributes such that they may be accessed by the security system. In storing the capture event attributes, embodiments disclosed herein may associate the capture event attributes with the security system in any feasible manner. For example, and without limitation, embodiments disclosed herein may store the capture event attributes as metadata appended to the video data captured by the cameras identified as being configured to capture video or images of the capture event.

As another example, the capture event attributes may be used to generate one or more graphical user interfaces (GUIs) depicting the capture event on the security system interface 100. As shown, the interface 100 includes a GUI 105 which includes a subset of the capture event attributes. The GUI 105 includes a textual description of a customer ID, a timestamp, a product ID and product description, a location in the store, and a camera capturing the capture event. The GUI 105 may be overlaid on the video data captured by the security camera (and saved with the video data). Alternatively, the GUI 105 may be stored separate from the stored video data. More generally, embodiments disclosed herein may use the capture event attributes to create any number and types of GUIs, charts, or any representation of the capture event attributes in order to facilitate loss prevention personnel's review of security video footage.

FIG. 1B illustrates an example security system interface 130 implementing techniques to synchronize scan activity with loss prevention cameras, according to one embodiment. As shown, the interface 130 is a composite of each of the three items scanned by the user 101 while in the retail store. The interface 130 depicts each capture event triggered by the mobile device 102 of the user, and includes the GUI 105 from FIG. 1A, as well as GUI 106 and 107, each corresponding to different capture events initiated by the user 101 in different parts of the retail store. Therefore, as shown, the GUI 106 depicts capture event attributes collected when the user 101 scanned a box of bolts in aisle 4, while the GUI 107 depicts capture event attributes collected when the user 101 scanned a hammer in aisle 6. In creating the interface 130, embodiments disclosed herein allow security personnel to easily identify the items scanned (and paid for) by the user 101. If the user 101 had ten items in their cart 104 when leaving the store, the interface 130 would allow security personnel to quickly determine that the user 101 has items in the cart 104 that were not paid for.

Generally, any techniques may be implemented to utilize the capture event data in a way to facilitate loss prevention personnel. For example, embodiments disclosed herein may output, to security personnel, only the frames of captured video (or still images) corresponding to each timestamp of each capture event for a given user. Such a technique may advantageously reduce the amount of video data that security personnel have to review to only those moments where the user 101 scanned a product.

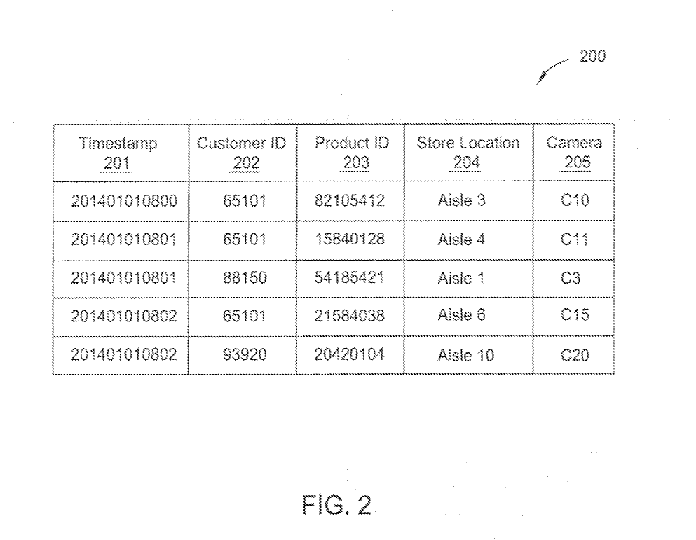

FIG. 2 illustrates an example data structure 200 to synchronize scan activity with loss prevention cameras, according to one embodiment. Generally, the data structure 200 may include any number and format of attributes for capture events captured by the mobile devices carried by users in a retail store. As shown, the data structure 200 includes a plurality of attributes 201-205 for a given capture event. The attributes include a timestamp 201, a customer ID 202, a product ID 203, a store location 204, and a camera 205. The timestamp 201 indicates the exact date and time that the user 101 scans a product using the mobile device 102. The customer ID 202 is a unique identifier of a customer (or the customer's mobile device 102). The product ID 203 is a unique identifier of a product or good offered for sale in the retail store. A store location 104 may indicate a location in the retail store that the capture event occurred. The store location 104 may be, as shown, specified as an aisle in the store, but any format sufficient to identify a location in a store may be used. For example, a department name or position data may be used. The camera 205 indicates an identifier of a security camera configured to monitor the specified store location 204. Therefore, as shown, the data structure 200 indicates that customer 65101 purchased a product having an identifier 82105412 at 8:00 AM on Jan. 1, 2014 in Aisle 3 of the retail store, which is covered by camera C10 in the security system. The particular attributes in the data structure 200 are exemplary, and should not be considered limiting of the disclosure, as any number of attributes may be included in the data structure without departing from the scope of the disclosure.

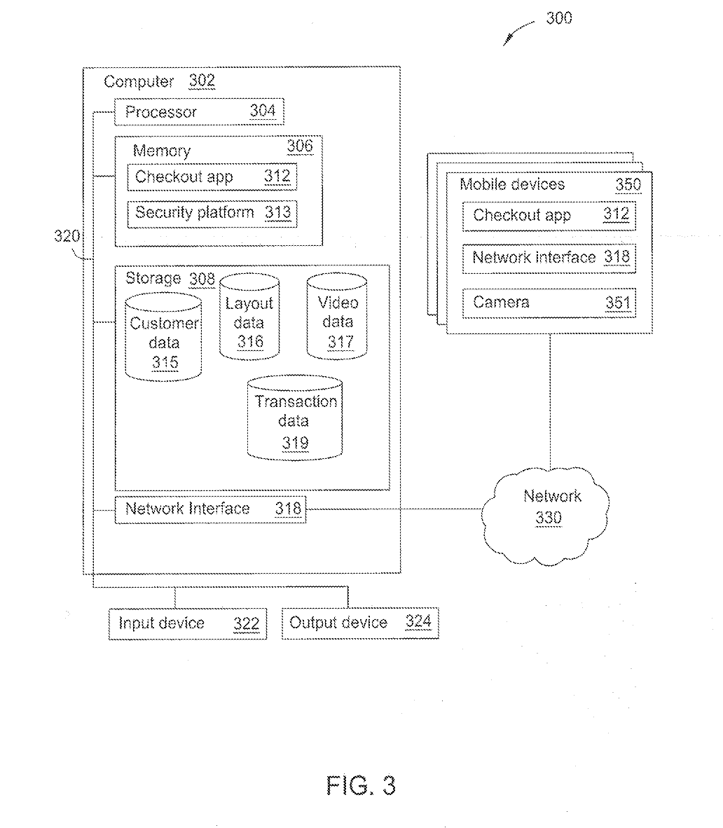

FIG. 3 illustrates a system 300 to synchronize scan activity with loss prevention cameras, according to one embodiment. The networked system 300 includes a computer 302. The computer 302 may also be connected to other computers, such as mobile devices 350, via a network 330. In general, the network 330 may be a telecommunications network and/or a wide area network (WAN). In a particular embodiment, the network 330 is the Internet.

The computer 302 generally includes a processor 304 connected via a bus 320 to a memory 306, a network interface device 318, a storage 308, an input device 322, and an output device 324. The computer 302 is generally under the control of an operating system (not shown). Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used. The processor 304 is included to be representative of a single CPU, multiple CPUs, a single CPU having multiple processing cores, and the like. The network interface device 318 may be any type of network communications device allowing the computer 302 to communicate with other computers via the network 330.

The storage 308 may be a persistent storage device. Although the storage 308 is shown as a single unit, the storage 308 may be a combination of fixed and/or removable storage devices, such as fixed disc drives, solid state drives, SAN storage, NAS storage, removable memory cards or optical storage. The memory 306 and the storage 308 may be part of one virtual address space spanning multiple primary and secondary storage devices.

The input device 322 may be any device for providing input to the computer 302. For example, a keyboard and/or a mouse may be used. The output device 324 may be any device for providing output to a user of the computer 302. For example, the output device 324 may be any conventional display screen or set of speakers. Although shown separately from the input device 322, the output device 324 and input device 322 may be combined. For example, a display screen with an integrated touch-screen may be used.

As shown, the memory 306 contains the checkout app 312, which is an application generally configured to process customer purchases in a retail store. In some embodiments, the customer purchases are processed by fixed point-of-sale computers, self checkout computers, and the like. In at least some other embodiments, the customer purchases are processed using a mobile device 350. In such embodiments, the checkout app 312 allows users to scan products with the mobile device 350 while shopping, and then pay for their selected products using the checkout app 312. In some embodiments, instead of paying through the checkout app 312, the user may pay for their items at a designated location (such as a self-checkout kiosk) in the retail store. In addition, the instance of the checkout app 312 on the computer 302 is configured to collect attributes of capture events triggered by instances of the checkout app 312 on the mobile devices 350, store the attributes in one or more of the customer data 315, video data 317, or transaction data 319, or directly pass the attributes to the security platform 313. By storing the attributes in the storage 308, or passing the attributes to the security platform 313, the checkout app 312 may associate the capture event data of the mobile shopping experience with the security system managed by the security platform 313.

For example, if a customer scans a box of chocolates using the checkout app 312 on a mobile device 350 in a supermarket, the instance of the checkout app 312 on the mobile device 350 may capture a timestamp when the capture event occurs. The checkout app 312 on the mobile device 350 may then transmit the timestamp, the identifier of the box of chocolates, an identifier of the mobile device 350 (and/or a customer ID) to the instance of the checkout app 312 executing on the computer 302. Optionally, the checkout app 312 on the mobile device 350 may also send any available information regarding the location of the mobile device 350. Upon receiving the information, the instance of the checkout app 312 executing on the computer 302 may determine the location of the mobile device 350 in the supermarket. The checkout app 312 may determine the location of the mobile device 350 by any feasible method, including without limitation, triangulating wireless signals from the mobile device 350, or RFID or NFC technology. Upon determining the location of the mobile device 350, the checkout app 312 may then determine what video camera in the security system is configured to capture video or images of this location. In at least one embodiment, the checkout app 312 may reference the layout data 316, which includes a detailed layout of the supermarket, including a mapping of video cameras to physical locations in the supermarket. For example, if the checkout app 312 determines that the customer scanned the chocolates in the bakery department, the checkout app 312 may reference the layout data 317 to determine that camera XYZ is configured to monitor the bakery department.

Having the relevant data attributes of the capture event, the checkout app 312 may then associate the data attributes (and therefore the capture event) with the security system, namely camera XYZ and/or video or image data from camera XYZ stored in the video data 317. To associate the attributes with the security system, the checkout app 312 may take any number of actions. For example, the checkout app 312 (or the security platform) may append the attributes as metadata to the video captured by camera XYZ proximate to the timestamp of the capture event. As another example, the checkout app 312 may store a record including the attributes of the capture event in the transaction data 319. In still another example, the checkout app 312 (or the security platform 313) may overlay the capture event attributes as a graphics object on the video captured by the camera XYZ proximate to the timestamp of the capture event. Furthermore, the checkout app 312 may cause camera XYZ to capture an image of the shopper when the capture event occurs. The security platform 313 may then store the captured image in the video data 317 for future retrieval.

As shown, the memory 306 also includes security platform 313, which is an application generally configured to manage a security system in a retail store, which may include a plurality of cameras that store video and image data in the video data 317. In some embodiments, the security platform 313 (or the checkout app 312) may sample different video sources (and/or image sources) to create composite images, composite videos, and the like. Furthermore, the security platform 313 or the checkout app 312 may be configured to access the transaction data 319 in order to generate one or more GUIs or other representations of capture events to overlay while playing back a video that does not include overlaid representations of capture events.

As shown, the storage 308 includes a customer data 315, layout data 316, video data 317, and transaction data 319. The customer data 315 includes customer information related to a plurality of customers, including without limitation, profile data, preference data, and the like. The layout data 316 includes a detailed layout of one or more retail stores, including a mapping of video cameras to physical locations in the each retail store. The video data 317 is a data store used to store video and images captured by security cameras in the retail store. The transaction data 319 includes detailed transaction records for each of a plurality of capture events initiated by a customer using the checkout app 312 on a mobile device 350. Generally, the transaction data includes capture event attributes. One example of a record stored in the transaction data 319 is the data structure 200. In some embodiments, a separate data structure (not pictured) is used to implement the point-of-sale/checkout functionality for each transaction processed by a mobile device using the checkout app 312.

As shown, the mobile devices 350 include, without limitation, an instance of the checkout app 312, a wireless network interface 319, and the camera 351. The camera 351 may be used to read any type of identification information on goods or products, such as bar codes or QR codes. In some embodiments, the mobile devices 250 may include local copies of the customer data 315, layout data 316, and the transaction data 319. Examples of mobile devices 350 include, without limitation, smart phones, tablet computers, portable computers, and mobile scanning devices.

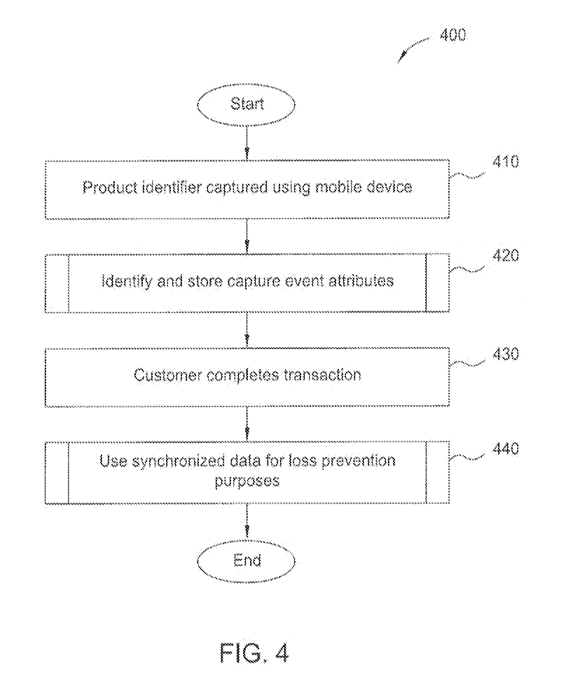

FIG. 4 is a flow chart illustrating a method 400 to synchronize scan activity with loss prevention cameras, according to one embodiment. Generally, the steps of the method 400 associate capture events from mobile devices used to scan products or other goods in a retail store with the security systems in the retail stores. For example, a timestamp of a capture event, along with other attributes of the capture event, may be associated with the video data captured by a security camera “witnessing” the capture event. Once the capture event is associated with the video data, loss prevention personnel may use the capture event attributes in any way to facilitate loss prevention. In at least some embodiments, the checkout app 312 performs the steps of the method 400.

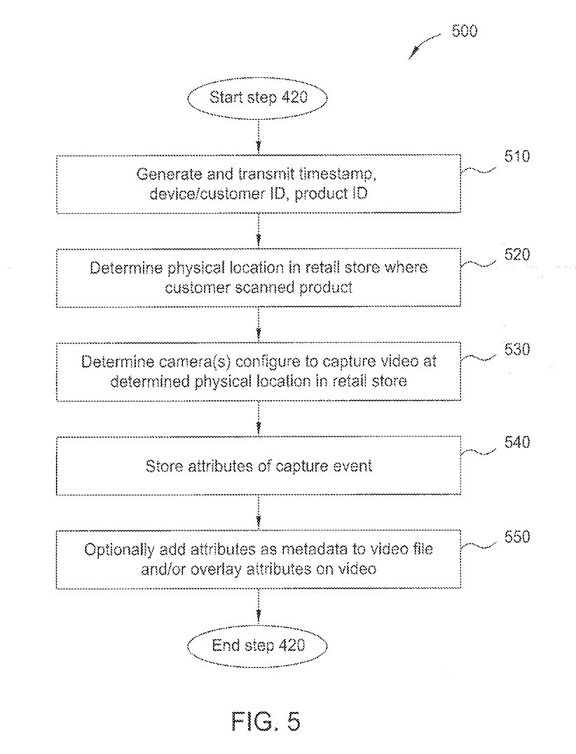

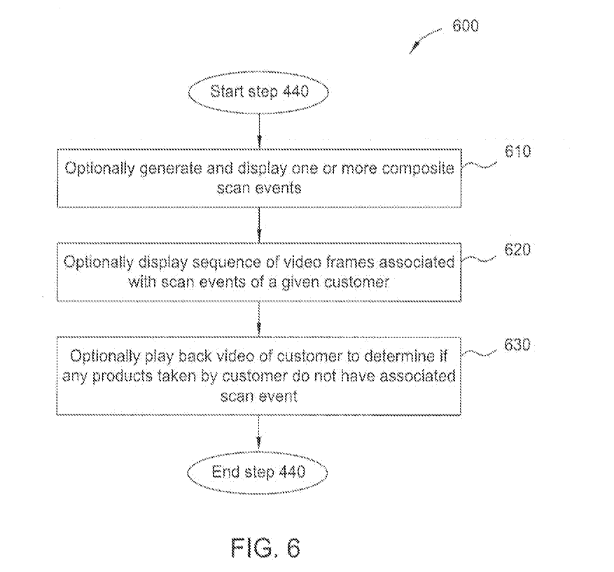

At step 410, a customer may capture a product identifier of a product using a mobile computing device that executes the checkout app 312. For example, the customer may use a mobile device to scan a new computer, and subsequently place the computer in their shopping cart. At step 420, described in greater detail with reference to FIG. 5, the checkout app 312 may identify and store the capture event attributes. Generally, the capture event attributes may include, without limitation, a timestamp when the customer scans the product at step 410, a location in the store where the product was scanned, an identifier of camera capturing video or images of the capture event, and identifiers of the mobile device (or customer) and the product. At step 430, the customer may complete a sales transaction whereby the customer pays for scanned items. At step 440, described in greater detail with reference to FIG. 6, security personnel may use the synchronized data for loss prevention purposes. For example, the security personnel may be presented with only the frames of video where a given customer scans products. Generally, the synchronized data may be used in any way for loss prevention purposes.

FIG. 5 is a flow chart illustrating a method 500 corresponding to step 420 to identify and store capture event attributes, according to one embodiment. Generally, the steps of the method 500 associate attributes of capture events from mobile devices with security camera video data. In at least some embodiments, the checkout app 312 executes the steps of the method 500. At step 510, the instance of the checkout app 312 executing on the mobile device scanning the product at step 410 generates a timestamp, and transmits the timestamp along with a product ID of the product being scanned (such as the computer of step 410), and at least one of a mobile device ID and a customer ID. In some embodiments, the checkout app 312 may also transmit GPS or other location-based data (such as approximated location data generated using wireless signals). At step 520, the instance of the checkout app 312 executing on the computer 302 determines the physical location in the retail store where the capture event occurred. The checkout app 312, if not provided with the location data at step 510, may determine the physical location based on triangulating wireless signals, RFID, NFC, or image analysis to detect the shopper or the mobile device on frames captured by the security cameras. More generally, the checkout app 312 may use any feasible method to determine the location of the capture event in the retail store.

At step 530, the checkout app 312 may determine which cameras are configured to capture video at the location in the store determined at step 520. In at least some embodiments, the checkout app 312 may reference the layout data 316 to access mappings between locations in the store and the video cameras capturing video and/or images in those locations of the store. In some embodiments, the checkout app 312 may cause the identified cameras to capture one or more still images of the customer subsequent to the capture event. At step 540, the checkout app 312 may store the collected attributes of the capture event. For example, the checkout app 312 may store a record similar to the records in data structure 200 to the transaction data 319, in order to associate the capture event with the security infrastructure. At step 550, the checkout app 312 may optionally add the capture event attributes as metadata to the video files generated by the cameras identified at step 530. Additionally or alternatively, the checkout app 312 may overlay the capture event attributes on the video data proximate to the timestamp of the capture event. Generally, the checkout app 312 may take any feasible steps to associate the capture event with the video data (or other data) of the security system.

FIG. 6 is a flow chart illustrating a method 600 corresponding to step 440 to use synchronized data for loss prevention purposes, according to one embodiment. Generally, the steps of the method 600 provide techniques to assist loss prevention personnel in identifying loss. Although depicted as a flow chart, one, several, or all of the steps of the method 600 may be performed in any given instance or implementation. Furthermore, it should be appreciated that steps not expressly recited in the method 600 are contemplated by the disclosure, as any number or type of loss prevention techniques may be implemented as a product of associating mobile scan data with security system camera data and software. In some embodiments, the security platform 313 performs the steps of the method 600.

At step 610, the security platform 313 may optionally generate and display one or more composite capture events. For example, if a user scanned five items throughout a store, the security platform 313 may display a composite image of each capture event on a single screen in order to allow security personnel to determine if the customer placed any products in their cart or basket without scanning them. At step 620, the security platform 313 may optionally display a sequence of video frames associated with capture events for a given customer (or customers). For example, if the security personnel is monitoring shopper ABC, the security platform 313 may pull only those frames of video or image data that are associated with capture events of shopper ABC. If only three capture events are present, and the customer only paid for three items, but the customer possesses four items, loss may be prevented. At step 630, the security platform 313 may optionally play back video of a customer to determine if any products taken by the customer do not have an associated capture event. For example, if the stored video data generated by the video camera is overlaid with GUIs including metadata of capture events, the loss prevention personnel may detect, during playback of the stored video data, one or more instances where the customer placed items in their cart, but did not scan the items using the mobile device.

Generally, once the security system data has been enriched with event data (such as scans, payments, and the like), security personnel may take any steps to prevent loss. For example, the checkout app 312 and/or the security platform 313 may monitor scan activity across a store. If the checkout app 312 and/or the security platform 313 determine that a product scan has not taken place within a specified amount of time, the checkout app 312 and/or the security platform 313 can highlight this area as a candidate area for possible loss. Likewise, if there are high numbers of capture events in other areas, the checkout app 312 and/or the security platform 313 may identify these areas as less likely to be candidate areas for possible loss. Therefore, capture events may provide insight as to where the greater risks of loss exist, and real-time feeds may switch around the store to focus on areas where there are no capture events.

Advantageously, embodiments disclosed herein associate capture events with security system software and video data in order to reduce the risk of loss inherent in mobile shopping and self checkout. By collecting the relevant attributes of a capture event, embodiments disclosed herein may associate each capture event with one or more frames of video (or still images) of the security system, thereby facilitating review of the video and images by security personnel, and reducing the risk of loss.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications, such as the checkout app 312, or related data available in the cloud. For example, the checkout app 312 could execute on a computing system in the cloud and capture event scan attributes. In such a case, the checkout app 312 could create a record of the capture event and store the capture event attributes at a storage location in the cloud. Doing so allows a user to access this information from any computing system attached to a network connected to the cloud (e.g., the Internet).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
receiving, via a computer network connection, information for a product scan indicating that a product has been scanned for purchase by a mobile checkout application executing on a mobile device; and
storing, in a computer-readable storage medium and by operation of one or more computer processors, a plurality of attributes describing the product scan and identification information of an image capture device in the retail store configured to capture video of the product scan.

2. The method of claim 1, further comprising:
upon determining that the product has been scanned, causing the image capture device to capture an image of the location in the retail store where the product was scanned.

3. The method of claim 1, further comprising:
storing, in a video captured by the image capture device, a representation of the timestamp, the product identifier, and a mobile device identifier of the mobile device.

4. The method of claim 1, wherein the location of the product scan is determined by at least one of:
determining a location of the mobile device;
determining a product location of the product in the retail store; and
identifying, at a time proximate to the timestamp, at least one of the mobile device and the product in the video captured by the image capture device.

5. The method of claim 4, wherein the location of the mobile device is determined by at least one of: (i) triangulating a wireless signal of the mobile device, (ii) detecting a radio-frequency identification (RFID) device of the mobile device, (iii) detecting a near field communication (NFC) device of the mobile device, and (iv) location information provided by the mobile device.

6. The method of claim 1, wherein the identification information of the image capture device is determined by identifying, in a store layout, the image capture device assigned to monitor the location of the product scan in the retail store.

7. The method of claim 1, wherein determining that the product has been scanned comprises receiving a product scan indication from the mobile checkout application, the method further comprising:
storing a mobile device identifier of the mobile device in the compute-readable storage medium.

8. A system, comprising:
one or more computer processors; and
a memory containing a program, which when executed by the one or more processors, performs an operation comprising:
receiving, via a computer network connection, information for a product scan indicating that a product has been scanned for purchase by a mobile checkout application executing on a mobile device; and
storing, in a computer-readable storage medium, a plurality of attributes describing the product scan and identification information of an image capture device in the retail store configured to capture video of the product scan.

9. The system of claim 8, the operation further comprising:
upon determining that the product has been scanned, causing the image capture device to capture an image of the location in the retail store where the product was scanned.

10. The system of claim 8, the operation further comprising:
storing, in a video captured by the image capture device, a representation of the timestamp, the product identifier, and a mobile device identifier of the mobile device.

11. The system of claim 8, wherein the location of the product scan is determined by at least one of:
determining a location of the mobile device;
determining a product location of the product in the retail store; and
identifying, at a time proximate to the timestamp, at least one of the mobile device and the product in the video captured by the image capture device.

12. The system of claim 11, wherein the location of the mobile device is determined by at least one of: (i) triangulating a wireless signal of the mobile device, (ii) detecting a radio-frequency identification (RFID) device of the mobile device, (iii) detecting a near field communication (NFC) device of the mobile device, and (iv) location information provided by the mobile device.

13. The system of claim 8, wherein the identification information of the image capture device is determined by identifying, in a store layout, the image capture device assigned to monitor the location of the product scan in the retail store.

14. The system of claim 8, wherein determining that the product has been scanned comprises receiving a product scan indication from the mobile checkout application, the operation further comprising:
storing a mobile device identifier of the mobile device in the compute-readable storage medium.

15. A computer program product, comprising:
a computer-readable storage medium having computer-readable program code embodied therewith, the computer-readable program code comprising:
computer-readable program code configured to receive, via a computer network connection, information for a product scan indicating that a product has been scanned for purchase by a mobile checkout application executing on a mobile device; and
computer-readable program code configured to store a plurality of attributes describing the product scan and identification information of an image capture device in the retail store configured to capture video of the product scan.

16. The computer program product of claim 15, further comprising:
computer-readable program code configured to, upon determining that the product has been scanned, cause the image capture device to capture an image of the location in the retail store where the product was scanned.

17. The computer program product of claim 15, further comprising:
computer-readable program code configured to store, in a video captured by the image capture device, a representation of the timestamp, the product identifier, and a mobile device identifier of the mobile device.

18. The computer program product of claim 15, wherein the location of the product scan is determined by at least one of:
determining a location of the mobile device;
determining a product location of the product in the retail store; and
identifying, at a time proximate to the timestamp, at least one of the mobile device and the product in the video captured by the image capture device.

19. The computer program product of claim 18, wherein the location of the mobile device is determined by at least one of: (i) triangulating a wireless signal of the mobile device, (ii) detecting a radio-frequency identification (RFID) device of the mobile device, (iii) detecting a near field communication (NFC) device of the mobile device, and (iv) location information provided by the mobile device.

20. The computer program product of claim 15, wherein the identification information of the image capture device is determined by identifying, in a store layout, the image capture device assigned to monitor the location of the product scan in the retail store.
